(19) United States
(12) Patent Application Publication
(10) Pub. No.: US 2009/0125931 A1
(43) Pub. Date: May 14, 2009

(54) Turntable device and disk driving device having the same

(75) Inventors: Viatcheslav Smirnov, Suwon-si (KR); Young-Sun Yoo, Suwon-si (KR); Ho-Jun Yoo, Suwon-si (KR); Kyung-Seob Shin, Ansan-si (KR)

Correspondence Address: STAAS & HALSEY LLP, SUITE 700, 1201 NEW YORK AVENUE, N.W., WASHINGTON, DC, 20005, US

(73) Assignee: Samsung Electro-Mechanics Co., Ltd., Suwon (KR)

(21) Appl. No.: 12/149,455

(22) Filed: May 1, 2008

(30) Foreign Application Priority Data
Nov. 12, 2007 (KR) 10-2007-0114897

(51) Int. Cl. G11B 17/03

(52) U.S. Cl. 720/703

(57) ABSTRACT

A turntable device and a disk driving device having the same are disclosed. A turntable device for securing a disk includes: a cone part, which receives the disk in a detachable manner; a base, on which the disk may be mounted, and on which a boss is formed; and a yoke, which is coupled to the boss, and which supports the cone part in a manner such that the cone part is separated from the boss and is capable of sliding. This turntable device can improve alignment between the rotation centers of the motor and the disk, even in high-speed rotations.

### CROSS-REFERENCE TO RELATED APPLICATIONS

This application claims the benefit of Korean Patent Application No. 10-2007-0114897 filed with the Korean Intellectual Property Office on Nov. 12, 2007, the disclosure of which is incorporated herein by reference in its entirety.

### BACKGROUND

1. Technical Field

The present invention relates to a turntable device and a disk driving device having the turntable device.

2. Description of the Related Art

In general, a disk drive may include a deck base which forms the main body, a means for loading or unloading a disk onto or from the deck base, a means for rotating the disk loaded onto the loading/unloading means at a particular speed, and a means for recording or retrieving information onto or from the recording surface of the disk while traversing across the radius of the disk rotated by the rotating means.

Several types of disk drives are known to the public, examples of which may include disk drives in which a disk is loaded and unloaded while mounted on a tray, or in which a disk is encased in a cartridge that is received into or ejected from the deck base.

A spindle motor may be employed as the means for rotating the disk can be a spindle motor, while a pickup unit may typically be used as the means for recording or retrieving information onto/from the recording surface of the disk. Also, a disk chucking device for securing the disk may be equipped on the deck base, where the disk may be inserted onto the chuck base and secured by chuck chips, etc.

An important matter in such a disk drive is to align the center of the disk mounted on the chuck base with the center of the chuck base itself. If the centers of the chuck base and the disk are misaligned, the high-speed rotation of the disk can further increase the eccentricity between the centers and can cause various vibrations and noise.

In particular, DVD devices equipped with high-capacity storage apparatus such as BD or HD systems require rotations of even higher speeds. In regard to the actions of reading and writing data for these devices, the mechanical strengths of the turntable device and the disk driving device, as well as the center alignment actions, are of critical importance in avoiding errors.

The cone part, which supports the disk in a turntable device, may slide along the rotating shaft of the motor. Here, the length along which the cone part slides may be shorter, compared to the diameter of the supported disk. Also, there are always tolerances between the rotating shaft of the motor and the inner perimeter of the cone part, while the mechanical strength between the cone part and the rotating shaft may not be sufficient to provide satisfactory alignment. As such, there is a risk of errors occurring during reading or writing actions.

### SUMMARY

An aspect of the invention provides a turntable device and a disk driving device equipped with the turntable device, in which the alignment between the rotation centers of the motor and the disk is improved, even in high-speed rotations.

Another aspect of the invention provides a turntable device for securing a disk, which includes: a cone part, which receives the disk in a detachable manner; a base, on which the disk may be mounted, and on which a boss is formed; and a yoke, which is coupled to the boss, and which supports the cone part in a manner such that the cone part is separated from the boss and is capable of sliding. Here, the yoke can be coupled to an inner perimeter of the boss.

In certain embodiments, an extension part can be formed on a perimeter of the boss, and the yoke can be coupled to the extension part.

The turntable device may further include an elastic member coupled to the base and configured to elastically support the cone part. Here, a holding part may be formed in the base in which to hold the cone part, while a first protrusion may be formed, which extends towards an inner side of the holding part to prevent the cone part from detaching, and a second protrusion may be formed, which extends outwards from a perimeter of the cone part in a corresponding relationship with the first protrusion.

Yet another aspect of the invention provides a disk driving device for driving a disk, which includes: a motor, to provide a driving force to the disk; a base configured to receive the driving force, on which a boss is formed, and on which the disk may be mounted; a cone part configured to receive the disk in a detachable manner; and a yoke, which is coupled to the boss, and which supports the cone part in a manner such that the cone part is separated from the boss and is capable of sliding. Here, the yoke can be coupled to an inner perimeter of the boss.

In certain embodiments, an extension part can be formed on a perimeter of the boss, and the yoke can be coupled to the extension part.

The disk driving device may further include an elastic member coupled to the base and configured to elastically support the cone part. Here, a holding part may be formed in the base in which to hold the cone part, while a first protrusion may be formed, which extends towards an inner side of the holding part to prevent the cone part from detaching, and a second protrusion may be formed, which extends outwards from a perimeter of the cone part in a corresponding relationship with the first protrusion.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating a turntable device according to a first disclosed embodiment of the invention.

FIG. 2 is a cross-sectional view illustrating a cone part according to a first disclosed embodiment of the invention.

FIG. 3 is a plan view illustrating a cone part according to a first disclosed embodiment of the invention.

FIG. 4 is a cross-sectional view illustrating a yoke according to a first disclosed embodiment of the invention.

FIG. 5 is a cross-sectional view illustrating a base according to a first disclosed embodiment of the invention.

FIG. 6 is a plan view illustrating a base according to a first disclosed embodiment of the invention.

FIG. 7 is a plan view illustrating a turntable device according to a first disclosed embodiment of the invention.

FIG. 8 is a partial plan view illustrating a turntable device according to a first disclosed embodiment of the invention.

FIG. 9 is a partial cross-sectional view illustrating a turntable device according to a first disclosed embodiment of the invention.

FIG. 10 is a cross-sectional view illustrating a turntable device according to a first disclosed embodiment of the invention, before a disk is mounted on.

FIG. 11 is a cross-sectional view illustrating a turntable device according to a first disclosed embodiment of the invention, after a disk is mounted on.

FIG. 12 is a cross-sectional view illustrating a turntable device according to a second disclosed embodiment of the invention.

FIG. 13 is a cross-sectional view illustrating a turntable device according to a second disclosed embodiment of the invention, before a disk is mounted on.

FIG. 14 is a cross-sectional view illustrating a turntable device according to a second disclosed embodiment of the invention, after a disk is mounted on.

FIG. 15 is a cross-sectional view illustrating a disk driving device according to a third disclosed embodiment of the invention.

### DETAILED DESCRIPTION

The turntable device and disk driving device having the turntable device, according to certain embodiments of the invention, will be described below in more detail with reference to the accompanying drawings. Those components that are the same or are in correspondence are rendered the same reference numeral regardless of the figure number, and redundant explanations are omitted.

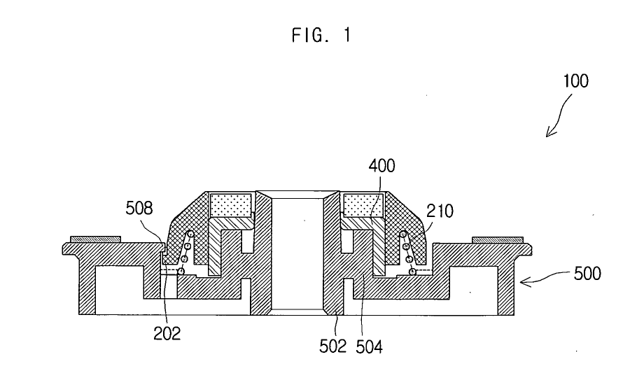

FIG. 1 is a cross-sectional view illustrating a turntable device according to a first disclosed embodiment of the invention. In FIG. 1 are illustrated a disk 10, a turntable device 100, a cone part 200, second protrusions 202, an elastic member 210, a yoke 400, a base 500, a boss 502, an extension part 504, a holding part 506, and first protrusions 508.

As illustrated in FIG. 1, a turntable device 100 according to the first disclosed embodiment of the invention may be a device for securing a disk 10, and may include a cone part 200, which the disk 10 may be mounted to or detached from; a base 500, on which the disk 10 may be mounted, and on which a boss 502 may be formed; and a yoke 400, which may be coupled to the boss 502, and which may slidably support the cone part 200 such that the cone part 200 may be separated from the boss 502. The turntable device 100 can provide improved alignment between the centers of rotation of the motor 1000 and the disk 10, even for rotations at high speeds.

The turntable device 100 can be a device on which a disk 10 may be placed, to secure the disk 10 to a motor 1000 in a disk driving device 1500. The disk 10 may be a storage medium for storing information.

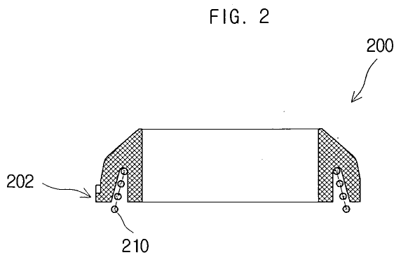

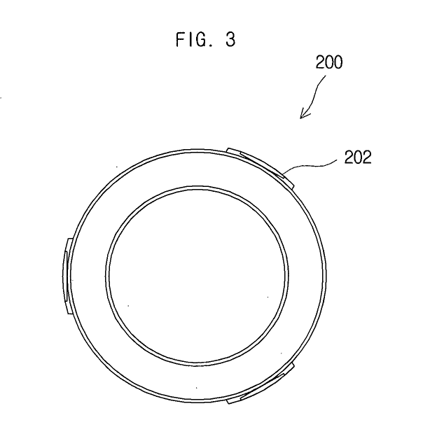

FIG. 2 is a cross-sectional view illustrating a cone part 200 according to the first disclosed embodiment of the invention, and FIG. 3 is a plan view illustrating a cone part 200 according to the first disclosed embodiment of the invention.

In the turntable device 100, the cone part 200 can be the portion inserted through the inner perimeter of the disk 10, to allow the disk 10 to be mounted to or and detached from the turntable device 100.

As illustrated in FIG. 2, an inner perimeter of the cone part 200 may be in contact with an outer perimeter of the yoke 400, to be supported by the yoke 400 in a manner such that the cone part 200 may be separated from the boss 502 and may be capable of sliding. Instead of sliding while being directly coupled to the rotating shaft 1004 of the motor 1000 or the boss 502 of the base 500, the cone part 200 according to this embodiment may be coupled such that it is separated by the yoke 400 from the rotating shaft 1004 or the boss 502, and may be supported to slide on the perimeter of the yoke 400. Therefore, the cone part 200 may be supported by the cylindrically shaped column formed by the yoke 400 such that the cone part 200 is capable of sliding, whereby the effects of tolerances present in the yoke 400 and the cone part 200 may be reduced, and the aligning of rotation centers between the disk 10 and the rotating shaft 1004 of the motor 1000 may be improved, even for rotations at high speeds.

As illustrated in FIG. 3, second protrusions 202, which extend outwards and which correspond with first protrusions 508, which will be described later in further detail, may be formed on the perimeter of the cone part 200. Here, to correspond means that, when the cone part 200 is coupled to the base 500, the second protrusions 202 may be formed in positions at which they may be latched onto the first protrusions 508. For example, if there are three first protrusions 508 in 120 degree intervals, there may also be three second protrusions 202 in 120 degree intervals. With the cone part 200 assembled to the base 500, the second protrusions 202 can be caught on the first protrusions 508, described later, to prevent the cone part 200 from becoming detached.

When assembling the turntable device 100, the cone part 200 may be inserted onto the base 500 and then rotated such that the second protrusions 202 may be latched onto the first protrusions 508. As such, the turntable device 100 according to this embodiment can be reassembled, should a problem occur, to respond to the problem in an economical manner.

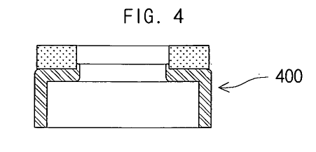

FIG. 4 is a cross-sectional view illustrating a yoke 400 according to the first disclosed embodiment of the invention. As illustrated in FIGS. 1 and 4, the yoke 400 may be coupled to the boss 502, and may support the cone part 200 such that the cone part 200 can undergo a sliding motion while separated from the boss 502. A magnet may be coupled onto an upper side of the yoke 400. The magnet may couple with a clamp (not shown) to secure the disk 10 to the turntable. The yoke 400 may be coupled to an extension part 504 formed on the perimeter of the boss 502. The cone part 200 may be inserted onto the yoke 400, and may be supported to be slidable along the perimeter of the yoke 400. As the yoke 400 may separate the cone part 200 from the boss 502 and provide a sliding surface, the cone part 200 may be provided with a longer length for sliding, so that tilting stiffness may be improved.

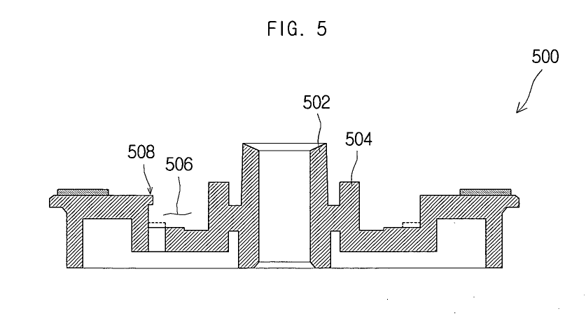

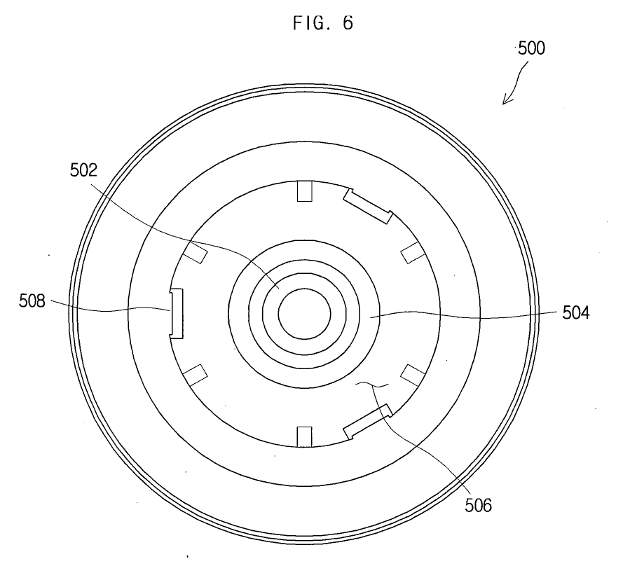

FIG. 5 is a cross-sectional view illustrating a base 500 according to the first disclosed embodiment of the invention, and FIG. 6 is a plan view illustrating a base 500 according to the first disclosed embodiment of the invention. The base 500 can be the portion where the disk 10 may be mounted, and where a boss 502 may be formed. The boss 502 may be formed in the center of the base 500, and may couple with the rotating shaft 1004 of the motor 1000, to receive the driving force transferred from the motor 1000. An extension part 504 may be formed on the outer perimeter of the boss 502, where the yoke 400 may be coupled to the extension part 504. The extension part 504 may increase the diameter of the cylinder-shaped support formed by the yoke 400, to increase the tilting stiffness of the cone part 200.

A holding part 506 may be formed in a surface of the base 500 on which the boss 502 is formed. The holding part 506 may provide a space in which the cone part 200 may be held. The holding part 306 can reduce the overall thickness of the turntable device 100, allowing a generally thinner turntable device 100. Also, the size of the holding part 506 may be adjusted, in order to control the length of cone part 200 protruding out from a disk 10, when the disk 10 is mounted on the turntable device 100. A surface on which to mount the disk 10 can be formed on an outer surface of the base 500, with which to support the disk 10.

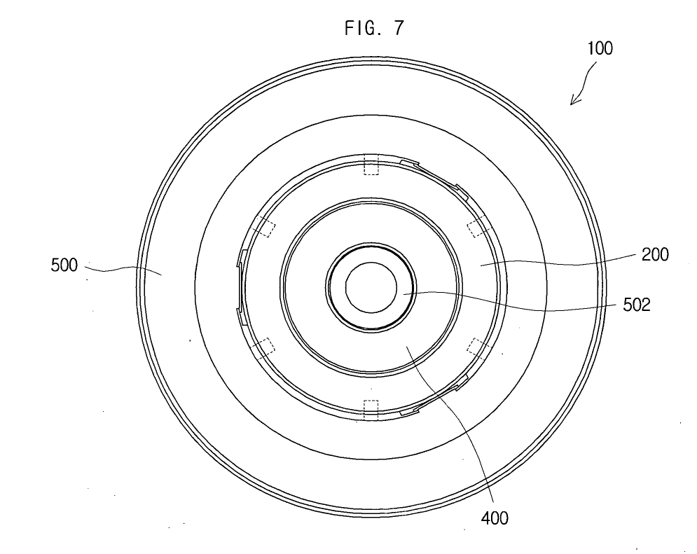

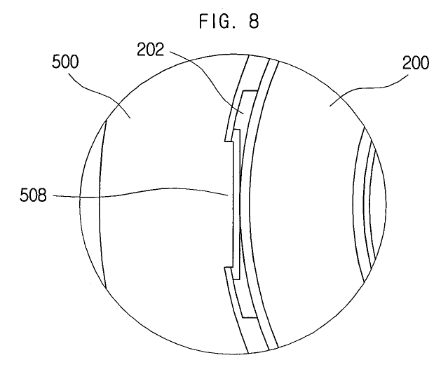

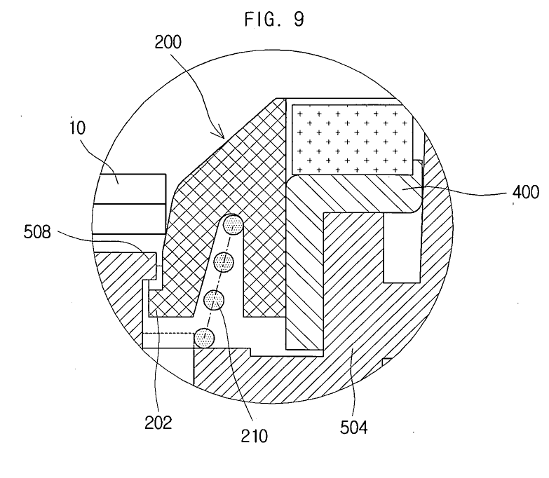

FIG. 7 is a plan view illustrating a turntable device 100 according to the first disclosed embodiment of the invention, FIG. 8 is a partial plan view illustrating a turntable device 100 according to the first disclosed embodiment of the invention, and FIG. 9 is a partial cross-sectional view illustrating a turntable device 100 according to the first disclosed embodiment of the invention.

As illustrated in FIG. 7, the first protrusions 508 and second protrusions 202 may be formed in positions corresponding with each other. When the cone part 200 is assembled to the base 500, the first protrusions 508 may latch onto the second protrusions 202 to prevent the cone part 200 from detaching. As illustrated in FIGS. 8 and 9, when a disk 10 is mounted on the turntable device 100, the cone part 200 may be lowered, so that the first protrusions 508 may not be caught on the second protrusions 202. Consequently, if a user wishes to separate the cone part 200 from the turntable device 100, the user may push and rotate the cone part 200 such that the second protrusions 202 do not latch onto the first protrusions 508, at which the cone part 200 may readily be separated.

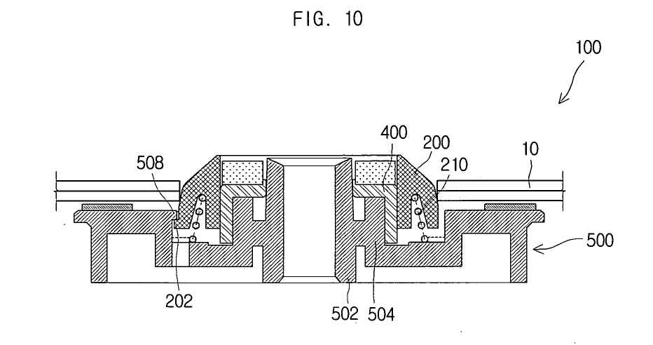

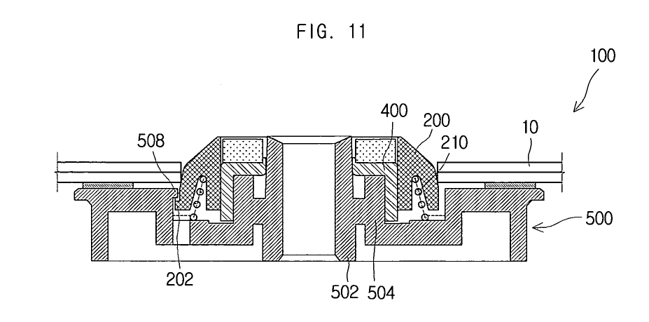

FIG. 10 is a cross-sectional view illustrating a turntable device 100 according to the first disclosed embodiment of the invention before a disk 10 is mounted on, and FIG. 11 is a cross-sectional view illustrating a turntable device 100 according to the first disclosed embodiment of the invention after a disk 10 is mounted on. As illustrated in FIG. 10, the turntable device 100 may further include an elastic member 210 coupled to the base 500 to elastically support the cone part 200. The elastic member 210 can be, for example, a compression coil spring. The elastic member 210 may support the cone part 200 and push the cone part 200 upwards. As the second protrusions 202 may be caught on the first protrusions 508 of the base 500, the cone part 200 may not be separated from the base 500.

As illustrated in FIG. 11, when a disk 10 is mounted on the turntable device 100, the cone part 200 may be lowered downwards in a sliding manner along the perimeter of the yoke 400. When the disk 10 is placed onto the cone part 200, the cone part 200 may rise again, due to the support of the elastic member 210, and the second protrusions 202 may be caught on the first protrusions 508.

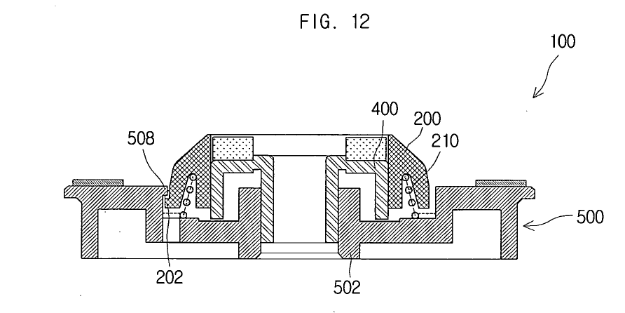

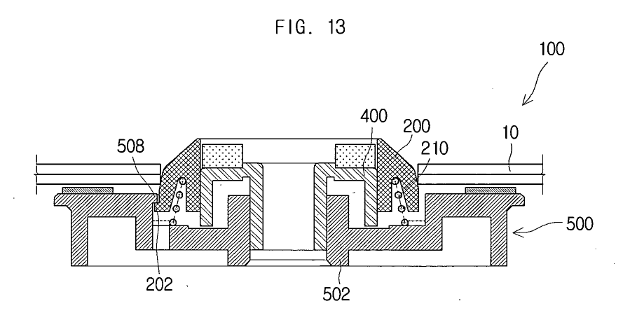

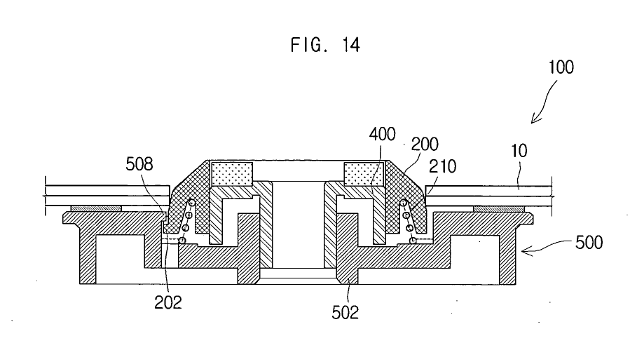

FIG. 12 is a cross-sectional view illustrating a turntable device 100 according to a second disclosed embodiment of the invention, FIG. 13 is a cross-sectional view illustrating a turntable device 100 according to the second disclosed embodiment of the invention before a disk 10 is mounted on, and FIG. 14 is a cross-sectional view illustrating a turntable device 100 according to the second disclosed embodiment of the invention after a disk 10 is mounted on.

As illustrated in FIG. 12, a turntable device 100 according to this embodiment may have the yoke 400 coupled to an inner perimeter of the boss 502. The yoke 400 may slidably support the cone part 200 such that the cone part 200 is separated from the boss 502, even in cases where the extension part 504 described above is not present. In this way, the cone part 200 may be provided with a cylinder-shaped support having a greater diameter and greater length. Also, the yoke 400 may be directly coupled with the rotating shaft 1004 for a more secure coupling.

Before the disk 10 is mounted on the turntable device 100, the cone part 200 may have second protrusions 202 engaged with first protrusions 508, and may be elastically supported by an elastic member 210. As the disk 10 is pressed towards the base 500, the cone part 200 may be lowered along the perimeter of the yoke 400, and may finally be inserted through the inner perimeter of the disk 10.

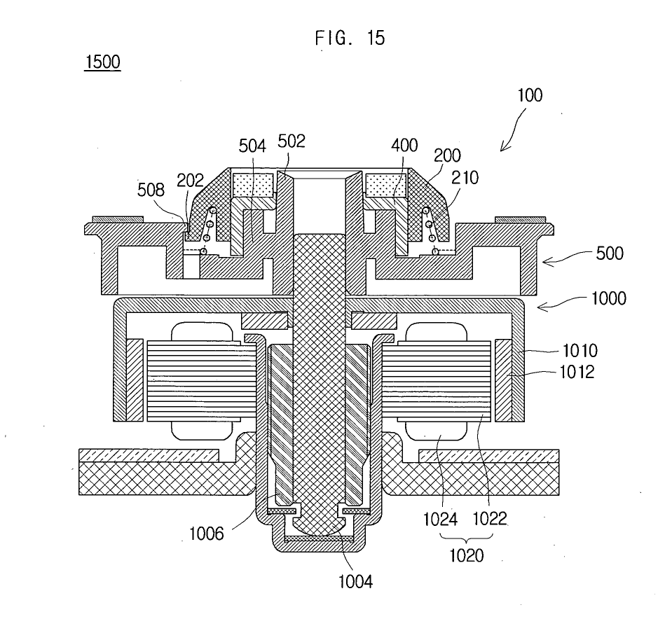

FIG. 15 is a cross-sectional view illustrating a disk driving device 1500 according to a third disclosed embodiment of the invention. In FIG. 15, there are illustrated a motor 1000, a rotating shaft 1004, a sleeve 1006, a rotor 1010, magnets 1012, teeth 1022, coils 1024, a stator 1020, and a disk driving device 1500.

A disk driving device 1500 according to this embodiment can be a device for driving a disk 10, and can include a motor 1000, which may transfer a driving force to the disk 10; a base 500, on which a boss 502 may be formed that receives the driving force, and on which the disk 10 may be mounted; a cone part 200, which the disk 10 may be mounted to and detached from; and a yoke 400, which may be coupled to the boss 502, and which may slidably support the cone part 200 such that the cone part 200 may be separated from the boss 502. The disk driving device 1500 can provide improved alignment between the centers of rotation of the motor 1000 and the disk 10, even for rotations at high speeds.

As shown in FIG. 15, the disk driving device 1500 may include a turntable device 100, onto which a disk 10 may be inserted and secured, as well as a motor 1000, which may provide a driving force to the turntable device 100. The motor 1000 can be a device for providing a driving force to the turntable device 100, and can be divided mainly into a rotor 1010, which may be coupled to the turntable device 100 to rotate together with the turntable device 100, and a stator 1020, which may provide a rotational force to the rotor 1010.

The stator 1020 may include teeth 1022 secured to a core, and coils 1024 secured around the perimeters of the teeth 1022. At an inner part of the teeth 1022, a sleeve 1006 may be included, which may support a rotating shaft 1004 and allow smoother rotation. An electric current can be inputted to the coils 1024, whereby an electrical field may be formed. The coils 1024 can be arranged adjacent to magnets 1024, which may be affixed to the rotor 1010. The rotating shaft 1004 may rotate together with the rotor 1010 and may serve to transfer the rotational force to the turntable device 100.

The rotor 1010 may rotate together with the rotating shaft 1004 and the turntable device 100, and may have a generally circular horizontal cross section. The rotor 1010 may be open downwards, and may include a cover portion that may be in contact with the turntable device 100. The cover portion can generally be shaped as a circular plate, and an upper surface of the cover portion may be in contact with the turntable device 100.

The rotating shaft 1004 may be inserted through the cover portion, while the boss 302 of the turntable device 100 may be inserted on and secured to the outer side of the insertion portion. In this way, the driving force of the rotating shaft 1004 may be transferred to the turntable device 100.

The turntable device 100 that forms a part of the disk driving device 1500 based on this embodiment of the invention can have substantially the same composition and can share substantially the same technical features as those of the turntable device 100 based on the previously described first disclosed embodiment of the invention.

As such, a disk driving device 1500 according to this embodiment may include a yoke 400, which may be coupled with the boss 502 and which may separate the cone part 200 from the boss 502 to support the cone part 200 in a manner that allows a sliding motion. This can provide the cone part 200 with a cylindrical support having a greater diameter and longer length, which can improve the tilting stiffness, as well as the center alignment. Also, first protrusions 508 and second protrusions 202 may be formed, to prevent the detaching of the cone part 200, while facilitating the assembly and disassembly of the cone part 200. Of course, this embodiment may also share other features presented with reference to the previously described first disclosed embodiment of the invention.

Moreover, a turntable device 100 according to the second disclosed embodiment of the invention as described above can be coupled with a motor 1000, to implement a disk driving device 1500 that shares the technical features described above.

As set forth above, certain embodiments of the invention can be utilized to improve the aligning of rotation centers between the motor and the disk, even for rotations at high speeds.

In addition, certain embodiments of the invention can be utilized to respond in an economical manner to modifications in the disk driving device, as well as to allow the reassembly of the cone part.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A turntable device for securing a disk, the turntable device comprising:
a cone part configured to receive the disk in a detachable manner;
a base configured to have the disk mounted thereon and having a boss formed thereon; and
a yoke coupled to the boss and supporting the cone part in a manner such that the cone part is separated from the boss and is capable of sliding.

2. The turntable device of claim 1, wherein an extension part is formed on a perimeter of the boss, and
the yoke is coupled to the extension part.

3. The turntable device of claim 1, wherein the yoke is coupled to an inner perimeter of the boss.

4. The turntable device of claim 1, further comprising:
an elastic member coupled to the base and configured to elastically support the cone part.

5. The turntable device of claim 4, wherein a holding part is formed in the base, the holding part having the cone part held therein.

6. The turntable device of claim 5, having a first protrusion is formed thereon and having a second protrusion formed thereon to prevent the cone part from detaching, the first protrusion extending towards an inner side of the holding part, and the second protrusion extending outwards from a perimeter of the cone part in a corresponding relationship with the first protrusion.

7. A disk driving device for driving a disk, the disk driving device comprising:
a motor configured to provide a driving force to the disk;
a base having a boss formed thereon and configured to have the disk mounted thereon, the boss configured to receive the driving force;
a cone part configured to receive the disk in a detachable manner; and
a yoke coupled to the boss and supporting the cone part in a manner such that the cone part is separated from the boss and is capable of sliding.

8. The disk driving device of claim 7, wherein an extension part is formed on a perimeter of the boss, and
the yoke is coupled to the extension part.

9. The disk driving device of claim 7, wherein the yoke is coupled to an inner perimeter of the boss.

10. The disk driving device of claim 7, further comprising:
an elastic member coupled to the base and configured to elastically support the cone part.

11. The disk driving device of claim 10, wherein a holding part is formed in the base, the holding part having the cone part held therein.

12. The disk driving device of claim 11, wherein a first protrusion is formed, the first protrusion configured to prevent the cone part from detaching and extending towards an inner side of the holding part,
and a second protrusion is formed, the second protrusion extending outwards from a perimeter of the cone part in a corresponding relationship with the first protrusion.
